(19) United States
(12) Patent Application Publication
(10) Pub. No.: US 2006/0168098 A1
(43) Pub. Date: Jul. 27, 2006

(54) Service offering for the delivery of partial information with a restore capability

(75) Inventors: David J. Allard, Boynton Beach, FL (US); Robert M. Szabo, Boca Raton, FL (US); James J. Toohey, Boca Raton, FL (US)

Correspondence Address: AKERMAN SENTERFITT, P. O. BOX 3188, WEST PALM BEACH, FL, 33402-3188, US

(73) Assignee: INTERNATIONAL BUSINESS MACHINES CORPORATION, Armonk, NY (US)

(21) Appl. No.: 11/022,964

(22) Filed: Dec. 27, 2004

(51) Int. Cl. G06F 15/16

(52) U.S. Cl. 709/217; 709/229

(57) ABSTRACT

A method for providing information to receivers including the step of receiving a request from a remotely located information requestor. The request can be associated with information controlled by an information controller and having a designated purpose. A transaction can be initiated to handle the request. At least one partial result can be generated for the transaction. The partial result can be tailored for information privileges granted to the information receiver by an information controller. The partial result can be conveyed to the information receiver along with a transaction status. The transaction status can indicate that the partial result is only a partial result for the request.

### BACKGROUND

1. Field of the Invention

The present invention relates to the field of information management and, more particularly, to the delivery of partial information to the right receivers at the right time.

2. Description of the Related Art

The information age is all about information exchanges, with an ultimate goal of providing information receivers with desired information upon demand in a reasonable fashion. Conflicting concerns, however, make this goal difficult to achieve. For example, information controllers often do not wish to give out information of value to information receivers, where valuable information can include private or confidential information about an individual as well as intellectual property owned or controlled by a business entity. Other conflicting concerns include concerns of information accessibility versus security, information breadth versus accuracy, and information completeness versus timely delivery of information.

Conventional data exchanges have focused upon granting individuals access to data contained within designated data repositories. Access is usually granted in a broad stroke, such as granting read, write, and update privileges to users against the entire or designated portions of each data repository. Further, a data storage methodology is generally selected that optimizes the data within the data repository for a single platform and storage methodology. Conventional exchanges focus upon synchronizing disparate data stores to share data contained within the stores. Simply put, conventional exchanges are data-centric exchanges that focus upon manipulating bits and bytes as opposed to information-centric concerns.

Consequently, information is currently being stored in a manner and fashion tailored for computers and not necessarily tailored for the needs of information receivers and/or information controllers. These entities care more about having the right information available to the right receivers, and only the right receivers, at the right time, and only at the right time. Conventional data processing and manipulation systems are inadequately designed to accomplish these information processing goals.

Even if a data processing system was designed in a more information-centric manner, other information processing challenges would remain. Assuming an information receiver is able to obtain information, there is no guarantee that the obtained information is complete or is delivered in a timely fashion.

Information processing systems have conventionally utilized automated decision making criteria to strike a balance between rapid information delivery and information completeness. Many situations exist, however, where it is more beneficial for an information receiver to have partial information delivered in a timely fashion than to have complete information delivered in a slightly longer timeframe. For example, a decision maker receiving information may prefer to base a decision upon partial information available in advance of the decision making point than receive complete information after the time for the decision has passed.

In other situations, complete information may be required before an information receiver can perform a task for which the information is sought. When partial information is insufficient and when complete information delivery is impossible within a desired timeframe, the information receiver may want to take corrective measures, such as rescheduling a task involving the desired information until a later time when that information is available.

For example, a physician can be the information receiver and the information sought can include an analysis of blood work from a patient's previous visit. Without results from the blood work, the physician may be wasting time meeting with the patient. Thus, it would be beneficial for the physician and patient to receive advance notice that the blood work information is not going to be available in time for a previously established appointment so as to reschedule an appointment to a later time, when the blood work information is available.

Conventional information systems do not provide information receivers an option to have information delivered in a gradual fashion nor do conventional systems provide advanced indications to information receivers that information will not be delivered on time.

### SUMMARY OF THE INVENTION

The present invention provides a method, system, and apparatus for delivering information that permits an information receiver to have information delivered in a gradual fashion. When the information receiver is provided with partial information, an indicator to this effect can be conveyed along with the partial information. The information receiver can determine whether additional, more complete, information is desired after analyzing the partial information. One option available to the information receiver is to cancel an information processing request before a complete result to the request is generated. When such an option is taken, the information providing system may halt current processes involved in generating the complete result and may attempt to restore the information processing environment to a state that the environment was in before the information processing task began. Thus, when a user halts an information processing task, the system performing the task may “rollback” conditions of the processing space, which may have changed to perform the processing task.

One aspect of the present invention may include a method for providing information to receivers. The method may include the step of receiving a request from a remotely located information requester. The request can be associated with information controlled by an information controller and having a designated purpose. A transaction can be initiated to handle the request. At least one partial result can be generated for the transaction. The partial result can be tailored for information privileges granted to the information receiver by an information controller. The partial result can be conveyed to the information receiver along with a transaction status. The transaction status may indicate that the partial result is only a partial result for the request.

Another aspect of the present invention can include an information service system. The system can include a central repository that provides request results to a plurality of information receivers responsive to requests submitted by at least one information requester. Each request result can be tailored to a purpose designated by the information requester. Moreover, each request result can be tailored to authorization privileges granted by an information controller to the corresponding information receiver. The information service system can convey partial or completed results to information receivers.

It should be noted that the invention can be implemented as a program for controlling a computer to implement the functions described herein, or a program for enabling a computer to perform the process corresponding to the steps disclosed herein. This program may be provided by storing the program in a magnetic disk, an optical disk, a semiconductor memory, any other recording medium, or distributed via a network.

### BRIEF DESCRIPTION OF THE DRAWINGS

There are shown in the drawings, embodiments which are presently preferred, it being understood, however, that the invention is not limited to the precise arrangements and instrumentalities shown herein.

FIG. 1 is a schematic diagram for a system that delivers partial results for requests in accordance to an embodiment of the inventive arrangements disclosed herein.

FIG. 2 details illustrative data constructs in accordance with an embodiment of the present invention.

FIG. 3 details illustrative data structures in accordance with an embodiment of the present invention.

FIG. 4 is a schematic diagram of an information service system that interacts with one or more remote systems in accordance with an embodiment of the inventive arrangements disclosed herein.

FIG. 5 is a schematic diagram of a system including an information client that interacts with an information service system in accordance with an embodiment of the inventive arrangements disclosed herein.

FIG. 6 is a flow chart illustrating a method that can be used by an information management system that provides partial results to information receivers in accordance with an embodiment of the inventive arrangements disclosed herein.

### DETAILED DESCRIPTION OF THE INVENTION

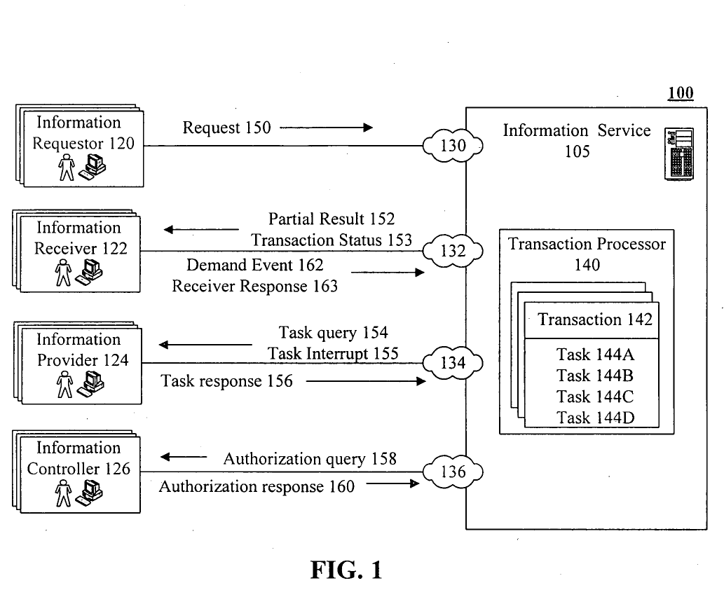

FIG. 1 is a schematic diagram for a system 100 that delivers partial results for requests in accordance to an embodiment of the inventive arrangements disclosed herein. In system 100, one or more information requesters 120 can submit a request 150 over network 130 to information service 105. Each request 150 may specify a need for information controlled by one or more information controllers 126. Request 150 can also have a designated purpose and one or more target information receivers 122.

Information service 105 can use transaction processor 140 to initiate a transaction 142 to handle request 150. Transaction 142 can utilize one or more tasks in generating a request result. For example, transaction 142, can utilize task 144A, task 144B, task 144C, and task 144D. The transaction processor 140 can process tasks 144A, 144B, 144C, and 144D in series and/or in parallel, depending upon transaction 142 specifications.

One or more tasks 144A, 144B, 144C, and 144D can query a record store internal to the information service 105. Additionally, one or more tasks 144A, 144B, 144C, and 144D can convey task query 154 over network 134 to information provider 124 that responsively provides task response 156. Task query 154 can initiate an information retrieval operation, an information confirmation operation, an information search operation, or any other information function that information provider 124 is configured to provide. The resulting information can be included in task response 156, which can be used to generate the request result.

Further, task query 154 can trigger the information provider 124 to perform a programmatic action related to the designated purpose. This programmatic action needs not be specifically tailored to provide information used in the construction of the request result, but can instead adjust an environmental state that extends the designated purpose. Accordingly, the task response 156 can indicate a result of the programmatic action that extends the designated purpose or can indicate an environmental state related to the designated purpose.

Request results can be conveyed to an information receiver in a gradual fashion causing one or more partial results 152 to be conveyed to the information receiver 122. A partial result 152 can be conveyed at a designated time, can be conveyed iteratively at established time intervals, can be conveyed responsive to completion of previously established result completion levels, and can be conveyed based upon other information service 105 determinable events. For example, information receiver 122 can trigger a demand event 162 that causes partial result 152 to be generated. In another embodiment, a demand event 162 could be triggered (not shown) by information requestor 120 or information provider 124.

Partial result 152 can be conveyed to the information receiver 122 along with a transaction status 153, which can indicate a level of completeness. For example, transaction status 153 can indicate, but is not limited to, such states as:

work not started

work started; no results returned; still working

work started; partial results returned; still working

work completed; all results returned; and

work completed; no results found/returned.

Upon receiving a partial result 152, information receiver 122 can convey a receiver response 163 to information service 105. Receiver response 163 can cause the transaction processor 140 to perform one or more programmatic actions in accordance with receiver response 163.

For example, receiver response 163 can halt the execution of transaction 142, can halt execution of a task relating to a portion of the partial result 152, can request additional information that causes transaction processor 140 to spawn a new task, and can perform any other appropriate action indicated by the receiver response 163.

When the receiver response 163 causes the transaction processor 140 to halt or terminate internal tasks, the information service 105 can send a task interrupt command 155 to each remotely located information provider 124 responding to a task query 154. The task interrupt command 155 permits the information provider 124 to terminate operations associated with the task query 154.

Since each partial result 152 and task query 154 can include information controlled by an associated information controller 126, a means to ensure that no entity receives unauthorized information is necessary. To this end, the information service 105 can convey an authorization query 158 across network 136 to information controller 126. The information controller 126 can responsively convey authorization response 160 to the information service 105 via network 136.

Only information which is authorized (as determined by an authorization response 160) for an information target (which can include an information receiver 122 and an information provider 124) is conveyed by the information service 105 to a designated information target. The authorization response 160 can authorize an information target to receive information for a one-time event or can grant continuous access. Further, the authorization response 160 can authorize a single information target or can authorize a category of information targets. Moreover, the authorization signified by the authorization response 160 can include temporal or purpose-specific constraints, which authorize access to an information target only when conditions related to the constraints are satisfied.

In one embodiment, to ensure the partial result 152 is conveyed to a prior information receiver (comprising a target information receiver 122, a target location, and combinations thereof), the information service 105 can determine a suitable delivery location for the partial result 152. For example, when the partial result 152 is to be presented to an information receiver 122 immediately before a meeting, a suitable delivery location could include the meeting location, which means that the partial results 152 could be conveyed to a computing device that the information receiver 122 can access from the meeting location. When the same partial result 152 is to be presented to the information receiver 122 a few days before the meeting, a suitable delivery location could include a work location of the information receiver 122. Consequently, information service 105 can selectively provide partial results 152 to different information delivery locations depending on a time of delivery for the partial results 152.

Each of the information requestor 120, the information receiver 122, the information provider 124, and the information controller 126 can include a person, a business entity, or an organization as well as a computing system, a computing device, an information service, or an information repository.

Networks 130, 132, 134, and 136 can represent any communication mechanism capable of conveying digitally encoded information. Each of the networks 130, 132, 134, and 136 can include a telephone network like a Public Switched Telephone Network (PSTN) or a mobile telephone network, a computer network like a local area network or a wide area network, a cable network, a satellite network, a broadcast network, and the like. Further, each of the networks 130, 132, 134, and 136 can use wireless as well as line based communication pathways. Digitally encoded information can be conveyed via network 130, 132, 134, or 136 in accordance with any communication protocol, such as a packet-based communication protocol or a circuit based communication protocol.

Information conveyance across networks 130, 132, 134, and 136 can occur in an open or secured fashion. For example, communications over networks 130, 132, 134, and 136 can use Secured Socket Layer (SSL) connections, can use private/public key encryption techniques, and can utilize Virtual Private Network (VPN) technologies.

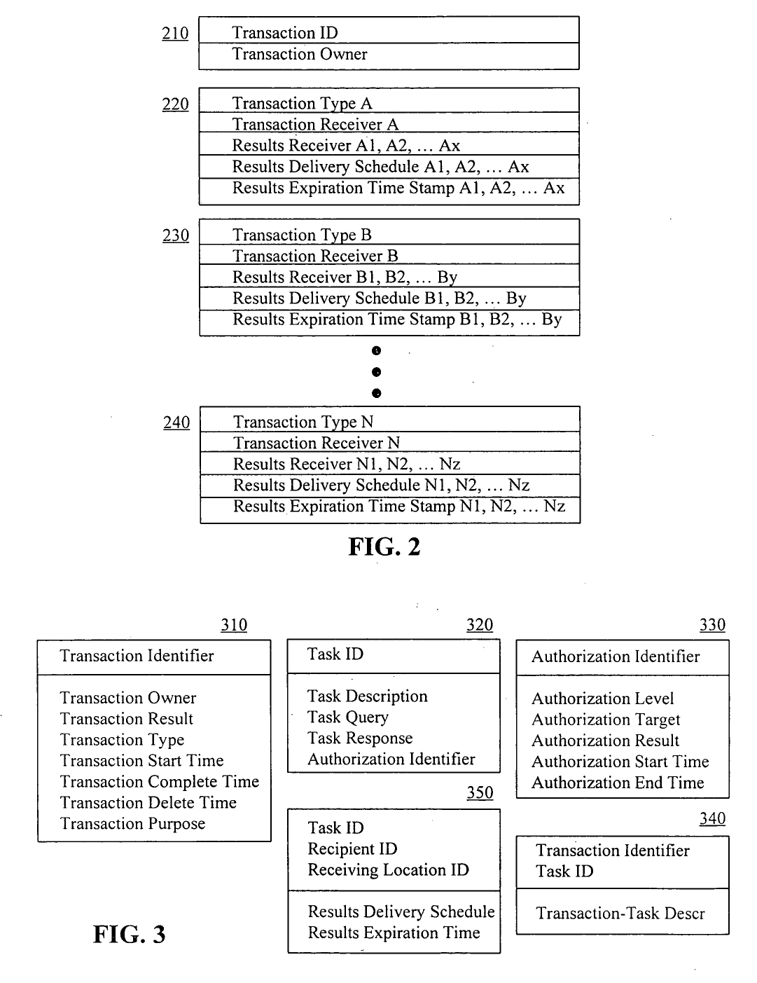

FIG. 2 details illustrative data constructs in accordance with an embodiment of the present invention. While the data constructs of FIG. 2 can be used by the information service 105 of FIG. 1, the invention is not to be limited in this regard.

More specifically, the data constructs of FIG. 2 define a new transaction type for coordinating information conveyances to assure information is provided to the right information receivers at the right time. The new transaction type identifies the owner of the transaction and can identify multiple parties that are to perform work for the transaction. Each of the multiple parties (transaction receiver) can receive a transaction specification tailored for that party. That is, for each transaction identifier one or more associated transaction types, one or more transaction receivers, one or more results receivers, one or more results delivery schedule entries, and one or more results expiration time stamps can be specified. Accordingly, the data construct of FIG. 2 identifies the owner of a transaction, the parties who are to do work, what type of work they are to do, where they are to send their results, when they are to send their results, and how long the results are good for.

In operation, it is envisioned that a person can initiate a request through his or her computer, PDA, phone, or other such device. The device (or a server to which the device was connected) can build a transaction request as depicted in FIG. 2. The transaction request can be conveyed to other parties (that can include one or more computers) involved in the transaction telling the parties what to do (e.g., search, compute, verify, etc.), when results are needed, and where to send the results. Additionally, the transaction request can specify the life span of the results. It should be noted that results may be sent to multiple parties, each result having a unique life span. Consequently, each recipient can know the duration for which results should be kept available to receivers and when the results should be disposed of, thereby freeing up local resources.

FIG. 3 details illustrative data structures for transaction 310, task 320, authorization 330, transaction-task linkage 340, and transaction-receiver linkage 350 in accordance with an embodiment of the present invention. The data structures of FIG. 3 can represent one embodiment for the data constructs presented in FIG. 2. It should be appreciated, however, that the data constructs of FIG. 2 can be implemented in any of a variety of data structures and are not to be construed as limited to the embodiment presented in FIG. 3, which is provided for illustrative purposes.

Transaction 310 can store data fields pertaining to individual transactions associated with one or more issued requests. Each transaction 310 can include a unique transaction identification key. Further, transaction 310 can include any of a variety of data attributes like a transaction owner, a transaction result, a transaction type, a transaction start time, a transaction complete time, a transaction delete time, and a transaction purpose.

The transaction owner can be the information requester that submitted a request which initiated the transaction. The transaction result can be the result generated in answer to the request. The transaction type can be one of a variety of previously established transaction types handled by the information service 105. Different tasks 320 and different information receivers can be associated with each transaction type. The transaction purpose can indicate a purpose for which a corresponding transaction was initiated, which can be different from the transaction type. In one embodiment, transaction results can be deleted from a data store accessible by the information recipient once the transaction purpose has been satisfied.

The transaction start time can represent a time at which the transaction begins and can be used for scheduling purposes. The transaction complete time can specify a time a transaction is to finish processing a request. The transaction delete time can indicate a time at which the transaction results are to be deleted from an information recipient's information store.

Task 320 can include information for each task spawned to produce a task response that is used when generating a transaction result. Task 320 can have a unique task identifier and attributes like a task description, a task query, a task response, and an authorization identifier. The authorization identifier can be a foreign key linking a task to authorization 330.

Linkage 340 can associate a transaction 310 with a task 320 in a one-to-one, one-to-many, many-to-one, and many-to-many fashion. Each association of linkage 340 can include a transaction-task description.

Linkage 350 can associate a task 320 with one or more information receivers. An information receiver can be specified by a recipient identifier and a receiving location identifier. Each association of linkage 350 can include a results delivery schedule and a results expiration time.

Authorization 330 can include information necessary to permit an associated transaction 310 or task 320 to execute. Further, the authorization 330 can signify information privileges for an information receiver. Authorization 330 can include an authorization identifier, an authorization level, an authorization target, and an authorization result. Since the authorization 330 can be established for a designated period or purpose, the authorization 330 can have one or more fields constraining an authorization, such as an authorization start time and an authorization end time.

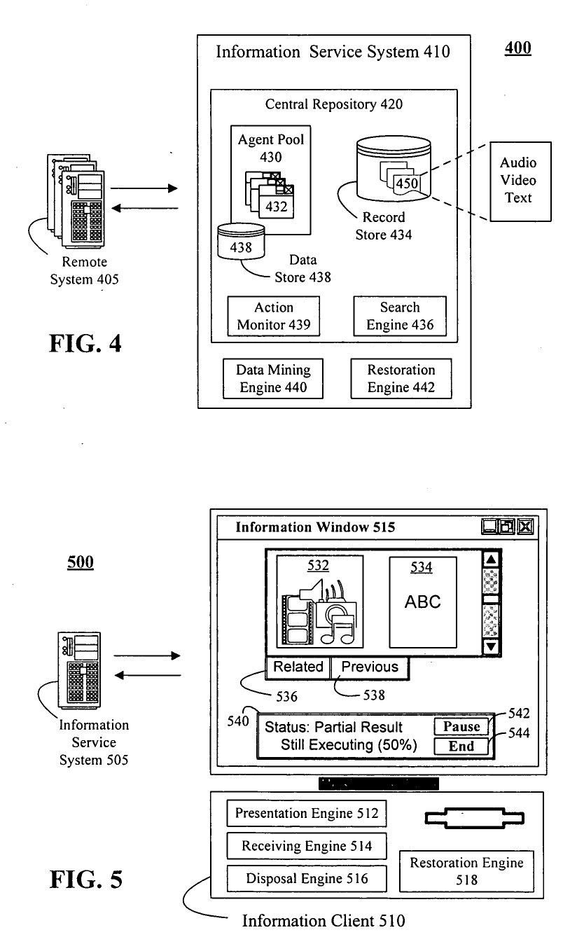

FIG. 4 is a schematic diagram of a system 400 including an information service system 410 that interacts with one or more remote systems 405 in accordance with an embodiment of the inventive arrangements disclosed herein. Information service system 410 can provide information service 105 of FIG. 1. Moreover, remote systems 405 can represent the information requestor 120, the information receiver 122, the information provider 124, and the information controller 126 of FIG. 1. The invention, however, is not to be limited in this regard.

The information service system 410 can include a central repository 420 in which information is stored. The information can be controlled so that information receivers only receive that information for which authorization has been granted by an information controller. Further, the information of the central repository 420 can be dispersed for a limited time in accordance with a designated information purpose of the information as stated in an information request.

The central repository 420 can include an agent pool 430 that provides a multitude of intelligent agents 432. Each intelligent agent 432 can manage one transaction at a time, where each transaction can produce a request result for a particular request. In producing request results, the intelligent agent 432 can generate one or more tasks, such as an information retrieval task, an authorization task, an information validation task, and the like. The intelligent agents 432 can utilize data store 438 to store details concerning steps taken to generate a request result. For example, algorithms, information providers, search criteria, user preferences, authorization entries, and other such details can be recorded within the data store 438 by intelligent agents.

Intelligent agents 432 can retrieve information from record store 434, local to the central repository 420 and from remotely located information providers using tools like search engine 436. The record store 434 can maintain several records 450, each record can include audio, video, sound, as well as textual information.

The search engine 436 can gather information from external information service systems, from the Internet or other online resource, from private networks, and other such sources. In one embodiment, information receivers can grant the information service 105 access to otherwise private information in return for using the service. In such an embodiment, the information receiver would be considered an information controller of this otherwise private information.

An action monitor 439 can record each action taken by an intelligent agent 432 and the current state of a computing environment at the time of the action. Further, when information within the central repository 420 is changed responsive to an action taken by an intelligent agent 430, the action monitor 439 can store the pre-action value. Information generated by the action monitor 439 can be used as an activity log, to re-start actions that have been paused at the state that the actions existed when halted, and to restore the information system 410 from an error.

A data mining engine 440 can sort through data, such as data within the record store 434, data store 438, and remote data stores (not shown), to identify patterns and relationships contained within the data. Accordingly, the data mining engine 440 can “mine” a quantity of data to generate information from that data.

Notably, since the data mining engine 440 does not disseminate the data that it analyzes to information receivers, it is not necessary for the information controller to grant privileges against the raw data being analyzed by the data mining engine 440 in order for the data mining engine 440 to operate. The privileges are taken into consideration, however, in the information generated by the data mining engine 440. Consequently, the information generated by the data mining engine 440 can be a sanitized version of raw data from which the information was generated.

A restoration engine 442 can restore the central repository 420 and remote system 405 to a pre-transaction state, thereby revoking a transaction. That is, the restoration engine 442 can be used to undo any and all actions performed when attempting to generate a result for a request. The restoration engine 442 can rely on information recorded by the action monitor 439 when restoring information within the central repository 420 to a pre-transaction state.

It should be appreciated that the restoration engine 442 can destroy results of a transaction and free up resources consumed by a transaction so that these resources are available for other transactions. For example, the restoration engine 442 can release an agent 432 used for the transaction back into the agent pool 430. The restoration engine 442 can also de-allocate any storage space within the record store 434 consumed in furtherance of the transaction. Moreover, the restoration engine 442 can convey a stop and restore command to each remote system 405 that is executing a routine at the behest of the information service system 410, where the remotely executed routine relates to the transaction being revoked. Upon receiving the stop and restore command, each remote system 405 can halt pending operations and can gracefully restore the environment of the remote system 405 to a pre-transaction state.

FIG. 5 is a schematic diagram of a system 500 including an information client 510 that interacts with an information service system 505. Information service system 505 can be the information service system 510 of FIG. 4. Additionally, the information client 510 can be a system through which one or more entities interact with the information service system 505. As such, the information client 510 can correspond to a system used by the information requestor 120, the information receiver 122, the information provider 124, or the information controller 126 of FIG. 1. The subject matter expressed and claimed herein, however, is not to be construed as being limited to the arrangements detailed within FIG. 5, which represents one of a variety of embodiments of the present invention.

The information client 510 can include an information window 515 in which information provided by the information service system 505 can be presented. The information window 515 can include digital media 532, like audio, video, and graphics, as well as text 534. Further, a user of the information window 515 can be provided an option to request related information 536, or to view previous 538 information provided by the information service system 505 in the past.

The information window 515 can indicate in a status box 540 the transaction status of the information being presented. The status box 540 can be necessary in situations where the information window 515 can display partial information so that the user does not have to wait until a complete result has been generated. It should be appreciated that sometimes having partial information available quickly can be more helpful than having more complete information available at a later time.

The status box 540 can include simple states for an information retrieval transaction such as information retrieval not started, still executing, or finished. The status box 540 can also include the level with which the presented result satisfies a corresponding information request, such as not satisfied, partially satisfied, and fully satisfied.

Additionally, the status box 540 can include one or more visual indicators (not shown) such as a battery meter or progress bar to indicate a state of a transaction. The status box 540 can also display a transaction start time (not shown), an expected transaction complete time (not shown), and an expected result completeness once the transaction has finished execution (not shown).

Complex transaction status states can be expressed within the status box 540. For example, the status box 540 can indicate that a transaction responsive to a request has not started but will start at a designated time. In another example, the status box 540 can indicate that the transaction has completed, but that the result generated by the transaction only partially satisfies the request. In still another example, the status box 540 can indicate that the transaction is currently halted pending authorization from an information controller, but that additional information is available should authorization be granted.

The status window 540 can include one or more user selectable buttons. For example, a pause button 542 can cause a transaction generating the results presented in information window 520 to pause at the current execution point. An end button 544 can cause a transaction to terminate, and for the information client 510 to be restored to a pre-transaction state. Selection of the end button 544 can also cause a restore operation to occur within the information service system 505. The restore operation can terminate executing routines relating to the transaction and can restore the information service system 505 to a pre-transaction state. The status box 540 can also include a button (not shown) permitting a user to request that partial information be immediately generated and presented within information window 515.

Additionally, the information window 515 can include a plurality of user specific settings (not shown) that permit customized information presentation. The user settings can also be used by the information service system 505 to generate information in a manner preferred by the user of the information window 515. Thus, the configuration settings can affect not only how information is presented, but can affect the content of the information provided to an information receiver as well.

The information client 510 can include a presentation engine 512, a receiving engine 514, a disposal engine 516, and a restoration engine 518. The presentation engine 512 can provide functions and routines used by the information window 515 to present information provided by the information service system 505. In one embodiment, the presentation engine 512 can provide security measures to ensure that information is only presented to authorized information receivers. For example, the information service system 505 can encrypt information conveyed to the information client 510, where the presentation engine 512 decrypts the information before presentation.

The receiving engine 514 can process incoming information for use by the information window 515. The receiving engine 514 can cache streamed content, can provide recovery mechanisms to re-initialize faulty transmissions, and can otherwise manage downloaded content.

The disposal engine 516 can ensure that information is erased from the information client 510 once the purpose for which the information was conveyed is satisfied. For example, information conveyed to the information client 510 can have an associated information expiration time or delete time that can activate the disposal engine 516. In another example, information can have a previously determined delete event associated with it. The delete event can by triggered either by processes within the information client 510 or by remotely located processes, such as an information service system 505 process.

The restoration engine 518 can restore the information client 510 to a state that the information client 510 was in before a transaction that generated a presented partial or complete result occurred. The restoration engine 518 can destroy results of a transaction present in the information client 510 and free up resources consumed by a transaction so that these resources are available to the information client 510 to handle other operations.

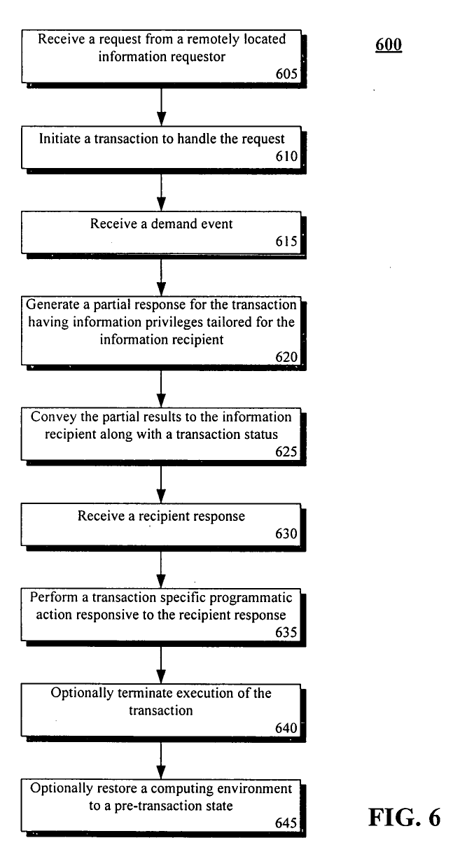

FIG. 6 is a flow chart illustrating a method 600 that can be used by an information management system that provides partial results to information receivers in accordance with an embodiment of the inventive arrangements disclosed herein. The method 600 can be performed in the context of an information service system, such as information service 105 of FIG. 1 and information service system 410 of FIG. 4.

The method 600 can begin in step 605, where a request can be received from a remotely located information requestor. The request can specify at least one information receiver and a designated request purpose. In step 610, a transaction can be initiated to handle the request. In step 615, a demand event can be received while the request is still processing. A demand event is an event that indicates that a partial result (or complete result if available) should be delivered as soon as possible to an information receiver.

In step 620, a partial response can be generated for the transaction. The partial response can include only that information that an information controller has authorized the information receiver to receive. A transaction status can also be generated to indicate the current state of completion of the transaction. In step 625, the partial results and the transaction status can be conveyed to the information receiver. In step 630, a receiver response can be received. The receiver response can indicate whether the partial information was sufficient and whether the transaction should continue to execute until a complete result is achieved. In step 635, a transaction specific programmatic action can be performed responsive to the receiver response.

In step 640, for example, execution of the transaction can be terminated, assuming a receiver response so indicates. In step 645, when a transaction was terminated a “roll-back” or restore operation can be performed. The restore operation restores the computing environment in which the transaction is executing to a state that the environment was in before execution of the transaction began.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for providing information to receivers comprising the steps of:
receiving a request from a remotely located information requester, the request associated with information controlled by an information controller and a designated purpose;
initiating a transaction to handle the request;
generating at least one partial result for the transaction, wherein the partial result is tailored for information privileges granted to the information receiver by an information controller; and
conveying the partial result to the information receiver along with a transaction status, said transaction status indicating that the partial result is only a partial result for the request.

2. The method of claim 1, wherein the transaction status indicates at least one state from the group of states consisting of: transaction responsive to request not started, transaction responsive to the request still executing, and transaction responsive to request complete.

3. The method of claim 1, wherein the transaction status indicates at least one state from the group of states consisting of: transaction responsive to request fully completed but request result generated for the transaction only partially satisfies the request, and transaction for the request halted pending authorization from information controller.

4. The method of claim 1, further comprising the step of:
receiving a receiver response to the conveyance of the partial result; and
performing a transaction specific programmatic action responsive to the receiver response.

5. The method of claim 4, wherein the receiver response indicates that the partial response is insufficient for the designated purpose.

6. The method of claim 5, wherein the programmatic action includes continuing to execute the transaction to generate a result more complete than the partial result.

7. The method of claim 5, wherein the programmatic action includes terminating execution of the transaction.

8. The method of claim 7, wherein the programmatic action restores a computing environment to a state that the computing environment was in before the transaction was initiated.

9. The method of claim 7, wherein the programmatic action includes issuing a stop and restore command to at least one remotely located computing device that is executing a task for the transaction.

10. The method of claim 9, wherein the stop and restore command signifies that each of the remotely located computing devices are to restore an associated remotely located computing environment to a state that the remotely located computing environment was in before the transaction was initiated.

11. The method of claim 1, further comprising the step of:
querying a record store to obtain information used in generating the at least one partial result, wherein the information requester and the information receiver are not authorized to directly access content of the record store.

12. The method of claim 1, further comprising the steps of:
determining that the designated purpose has been satisfied; and
responsive to the determining step, automatically deleting the partial result from a data store accessible by the information receiver.

13. The method of claim 1, further comprising the steps of:
after generating the at least one partial result, continuing to execute the transaction;
generating a more complete result than said partial result;
conveying the more complete result to the information receiver; and
responsive to conveying the more complete result, automatically deleting the partial result from a data store accessible by the information receiver.

14. The method of claim 1, further comprising the step of:
before the generating step, detecting a demand event that indicates a response for the request is demanded, wherein the generating step automatically occurs responsive to the detected demand event.

15. The method of claim 14, wherein the designated purpose is a business transaction involving the information receiver, and wherein the demand event is initiated by the information receiver to further the business transaction.

16. A machine-readable storage having stored thereon, a computer program having a plurality of code sections, said code sections executable by a machine for causing the machine to perform the steps of:
receiving a request from a remotely located information requestor, the request associated with an information controller and a designated purpose;
initiating a transaction to handle the request;
generating at least one partial result for the transaction, wherein the partial result is tailored for information privileges granted to the information receiver by an information controller; and
conveying the partial result to the information receiver along with a transaction status, said transaction status indicating that the partial result is only a partial result for the request.

17. The machine-readable storage of claim 16, said code sections further causing the machine to perform the steps of:
receiving a receiver response to the conveyance of the partial result that indicates the partial response is insufficient;
when the transaction is still executing halting execution of the transaction; and
restoring a computing environment to a state that the computing environment was in before the transaction was initiated.

18. An information service system comprising:
a central repository configured to provide request results to a plurality of information receivers responsive to requests submitted by at least one information requester, wherein each request result is tailored to a purpose designated by the information requester, and wherein each request result is tailored to authorization privileges granted by an information controller to the corresponding information receiver, wherein the information service system is configured to convey partially completed results to information receivers.

19. The information service system of claim 18, wherein said central repository further comprises:
a record store including information controlled by a plurality of information controllers and used by the information service system to provide results for requests, wherein information receivers are not granted direct access content of the record store; and
at least one intelligent agent that is a software agent configured to manage a transaction, wherein a transaction is initiated by the request and responsively generates at least one of said results.

20. The information service system of claim 18, further comprising:
a restoration engine configured to halt execution of software routines used to generate the request response before execution has completed and further configured to restore a computing environment of the information service system to a state that the computing environment was in before the request was processed by the information service system.
